(19) United States
(12) Patent Application Publication
(10) Pub. No.: US 2010/0237832 A1
(43) Pub. Date: Sep. 23, 2010

(54) CHARGING METHOD AND CHARGING SYSTEM

(76) Inventor: Juergen MACK, Goeppingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/724,748

(22) Filed: Mar. 16, 2010

(30) Foreign Application Priority Data
Mar. 19, 2009 (DE) 10 2009 001 670.8

(51) Int. Cl. H02J 7/04; H02J 7/00

(52) U.S. Cl. 320/150; 320/160

(57) ABSTRACT

The present invention relates to a method for electrically charging a plurality of rechargeable battery cells. The battery cells are embodied for a charging with a constant current and an increasing voltage in a first phase and for a charging with a constant voltage and a decreasing current in a second phase following the first phase. In the method, the battery cells are charged sequentially so that only one of the battery cells is charged at a time. The method features the fact that one battery cell is charged in the first phase, the charging of the relevant battery cell in the first phase is interrupted when a predetermined limit voltage is fallen below, and the charging is continued with another battery cell. The invention also relates to a charging system for electrically charging a plurality of rechargeable battery cells.

### CROSS-REFERENCE TO. RELATED APPLICATION

This application is based on German Patent Application 10 2009 001 670.8 filed Mar. 19, 2009.

### BACKGROUND OF THE INVENTION

1. Field of the Invention

The present invention relates to a method for electrically charging a plurality of rechargeable battery cells. The invention also relates to a charging system for electrically charging a plurality of rechargeable battery cells.

2. Description of the Prior Art

Multiple charging devices, also referred to as multibay charging devices, enable the automatic charging of a plurality of rechargeable battery cells without intervention by an operator. The charging devices can be embodied for a sequential charging of battery cells so that only a single electrical charging device is used. By contrast with the simultaneous charging of battery cells, this achieves in particular a cost savings and a space advantage. To monitor a charging procedure and to control the sequence in which battery cells are charged, the charging devices have a monitoring unit.

A multiple charging device of this kind is known from DE 42 16 045 A1, In addition to a control unit, the charging device has measuring devices for monitoring the voltage and temperature of the battery cells during the charging procedure. On the basis of the measured charging voltage, it is possible to detect whether the relevant battery cell has reached its maximum charge state so that the charging of this battery cell is interrupted and the charging procedure is continued with another battery cell. This method is also carried out when a predetermined temperature threshold is exceeded.

The charging device known from DE 42 16 045 A1 is designed for electrically charging NiCd batteries. In this case, the charging takes place with a charging current limited to a predetermined value, which is also referred to as the constant current charging method. In addition, rechargeable battery cells are known that are designed for a more complex charging procedure. These include the so-called IU-charging method, also referred to as the CCCV (constant current constant voltage) charging method. In this method, a battery cell is charged with a constant current and an increasing voltage in a first phase (I-charging) and once a maximum voltage is reached, the battery cell is charged with a constant voltage and a decreasing current in a second phase (U-charging).

### OBJECT AND SUMMARY OF THE INVENTION

The object of the present invention is to disclose an efficient method for electrically charging a number of rechargeable battery cells that are designed for an IU-charging method. Another object of the invention is to create an associated charging system for electrically charging such battery cells.

The invention proposes a method for electrically charging a plurality of rechargeable battery cells; the battery cells are designed for a charging with a constant current and an increasing voltage in a first phase and with a constant voltage and a decreasing current in a second phase following the first phase. The battery cells are charged sequentially so that only one of the battery cells at a time is charged. The method is characterized by the fact that one battery cell is charged in the first phase and once a predetermined limit voltage is reached, the charging of the relevant battery cell is interrupted in the first phase and the charging is continued with another battery cell.

In an IU-charging procedure, in the first phase (I-charging), a battery cell is usually supplied with a relatively high charge quantity in a relatively short time. The second phase (U-charging), in which the remaining charge quantity required to reach the full charge capacity is fed in, as a rule takes a relatively long period of time in comparison to the first phase. The method according to the invention takes this fact into account in order to feed the greatest possible charge quantity into a plurality of battery cells in the shortest possible time. In lieu of charging one battery cell in the first and second phases in immediate succession so that the relevant battery cell reaches its full charge capacity and only then is the charging procedure continued with another battery cell, the charging of the relevant battery cell is interrupted in the first phase (i.e. before reaching the second phase) and the charging procedure is continued with another battery cell. In this way, a greater energy quantity can be fed into the battery cells per unit of time. In other words, the method according to the invention avoids expending “precious” time storing a remaining capacity in one battery cell while in the same amount of time, a significantly greater energy quantity could be fed into another battery cell.

In a preferred embodiment, the predetermined limit voltage at which the charging in the first phase is interrupted is the voltage at which a battery cell is charged in the second phase. This voltage is also referred to as the final charging voltage. In other words, in the first phase, the relevant battery cell is charged until it reaches the maximum possible charge state achievable in the first phase.

In another preferred embodiment, for the case in which the predetermined limit voltage is present during the charging of the other battery cell, the charging of the other battery cell is interrupted. In this case, the other battery cell already has a corresponding charge quantity or charge state, which results in the presence of the predetermined limit voltage. The charging is therefore continued with another battery cell.

But if the number of battery cells to be charged is only two and the limit voltage is the final charging voltage, the charging procedure can also be continued with the other battery cell instead of terminating the charging of the other battery cell. In this case, the other battery cell is charged in the second phase.

In another preferred embodiment, all of the battery cells are initially charged in the first phase and then at least one of the battery cells is charged in the second phase. By charging all of the battery cells in the first phase, these battery cells receive a relatively large charge quantity in a relatively short time. By means of this, a greater “overall charge state” of the battery cells can be achieved in this time, as compared with a charging of the battery cells in a way in which the charging in the first and second phases is carried out one after another for each battery cell.

The appropriate battery cells for the method are preferably lithium-based battery cells. In particular, they can be lithium-ion or lithium-polymer cells.

In another preferred embodiment, a temperature of the battery cells is measured. If the measured temperature during a charging of a battery cell exceeds or falls below a predetermined temperature threshold, then the charging of the relevant battery cell is interrupted and the charging is continued with another battery cell.

The invention also proposes a charging system for electrically charging a plurality of rechargeable battery cells. The charging system has a charging device for selectively charging one of the respective battery cells; this charging device is embodied to charge a battery cell with a constant current and an increasing voltage in a first phase and to charge it with a constant voltage and a decreasing current in a second phase following the first phase. In addition, a measuring device is provided for determining a voltage during the charging of the battery cells as well as a control unit, which is connected to the charging device and measuring device and is for controlling the selective charging of the battery cells. The control unit is embodied to interrupt the charging of one battery cell in the first phase when a predetermined limit voltage is reached and to continue the charging with another battery cell. In a corresponding fashion, the charging system permits an efficient charging of battery cells so that the greatest possible charge quantity can be fed into the battery cells in a relatively short period of time.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows an example of the curve of a charge state in the conventional charging of a lithium-based battery cell, including the curves of a charging current and a charging voltage;

FIG. 2 is a schematic block circuit diagram of a charging system; and

FIG. 3 shows an example of a charging graph to illustrate an operation of the charging system from FIG. 2.

### DESCRIPTION OF THE PREFERRED EMBODIMENTS

Based on the following figures, an explanation will be given for embodiments of a charging method and charging system that can be used to efficiently charge a plurality of rechargeable battery cells in an IU-charging procedure. The battery cells used are in particular lithium-based battery cells such as lithium-ion or lithium-polymer cells. The battery cells here can be individual rechargeable batteries or accumulators. Alternatively, the battery cells can also be interconnected cells of a battery pack or accumulator pack that can be used in devices such as notebooks, digital cameras, mobile phones, power tools, etc.

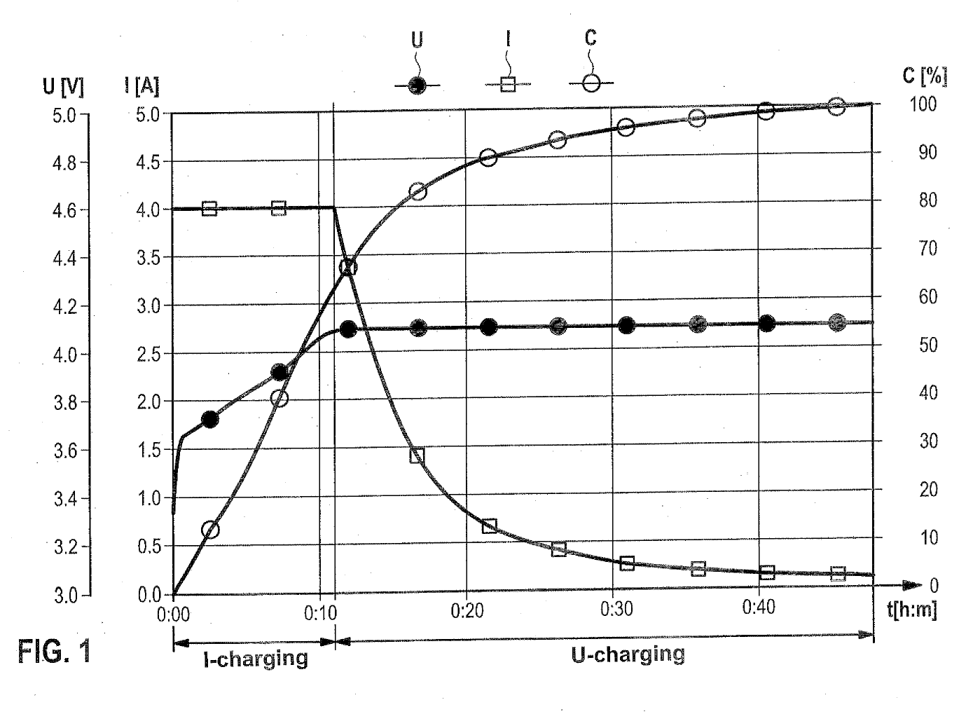

FIG. 1 shows an example of a charging curve in the conventional charging of a lithium-based battery cell that has been completely discharged before the charging procedure. The curves of a charge capacity C, indicated in percentage of the maximum charge capacity, a charging current I in amperes, and a charging voltage U in volts are plotted over time t, which is indicated in the [hours:minutes] format.

In a first phase of the charging, which is referred to here as “I-charging”, the charging is carried out with a constant current I that is limited by the charging device used. In this phase, the charge capacity C of the battery cell rises in an essentially linear fashion. Starting from a certain initial value, the voltage U also has a rising curve, which is essentially linear after a short time. When a maximum voltage U (approx. 4.1 V here) is reached, which is predetermined for the relevant battery cell and is also referred to as the final charging voltage, the charging is usually switched from a current regulation to voltage regulation so that in a second charging phase, referred to as “U-charging” here, charging is continued with a constant voltage U. In this phase, the charging current I decreases steadily (“current tail”) as the charge state of the battery cell increases until the battery cell has reached a charge capacity C of 100% or else the charging procedure can be terminated by means of a different shutoff criterion. The decrease in the charging current I in the U-charging phase results in the fact that the increase in the charge capacity C also decreases per unit of time t.

FIG. 1 shows that in the I-charging phase, by comparison with the U-charging phase, a relatively large charge quantity is fed into the battery cell in a short time. In this case, at the end of the I-charging phase, the battery cell has a charge capacity C of approx. 65% at a time t of approx. 11 minutes. In the subsequent U-charging phase, the maximum charge state C of 100% is only reached at a time t of approx. 48 minutes, i.e. the battery cell receives a charge capacity of only approx. 35% in the U-charging phase, which takes a period of approx. 37 minutes.

When sequentially charging a plurality of battery cells, in order to feed the greatest possible overall charge quantity into the battery cells in a short time, the invention proposes interrupting the charging of one battery cell during, or at the end of, the I-charging phase and continuing the charging with another battery cell in lieu of charging one battery cell in the first and second phases in immediate succession so that the relevant battery cell reaches its full charge capacity and only then continuing the charging procedure with another battery cell. Through the use of this principle, a relatively large energy quantity can be fed into the battery cells for a predetermined period of time that is shorter than a period of time required to fully charge all of the battery cells. The charging of one battery cell in the I-charging phase is interrupted when a predetermined limit voltage is reached. The predetermined limit voltage can in particular be the final charging voltage so that the charging of the relevant battery cell is interrupted at the end of the I-charging phase.

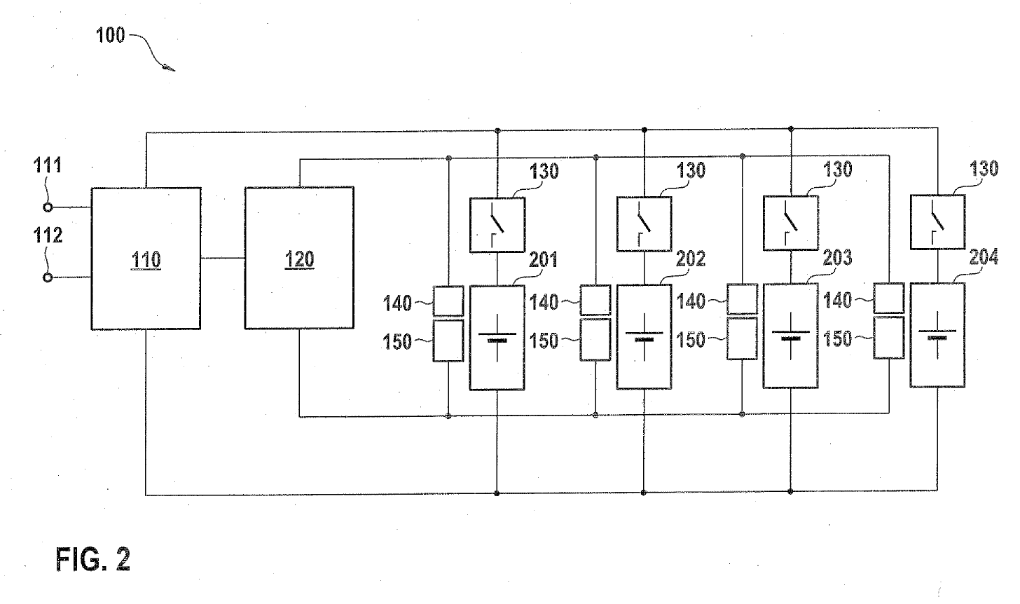

FIG. 2 is a schematic block circuit diagram of a charging system 100 that can be used to charge a plurality of rechargeable battery cells in accordance with the above-mentioned charging principle. For example, the charging system 100 is embodied to sequentially charge four battery cells 201, 202, 203, 204. The charging system 100 includes a power supply unit 110, which is connected via connections 111, 112 to a supply voltage, not shown, such as an a.c. voltage grid. The power supply unit 110, which can also be connected to the battery cells 201, 202, 203, 204 via corresponding lines, has components such as a transformer, which functions as a voltage converter, and a rectifier. In addition, the power supply unit 110 includes current regulators and voltage regulators that can be used to limit the charging current (I-charging phase) or the charging voltage (U-charging phase) in the battery cells 201, 202, 203, 204 to be charged.

In order to selectively connect only one of the battery cells 201, 202, 203, 204 to the power supply unit 110, the charging system 100 also has switches 130. The switches 130 here are activated and deactivated by means of a control unit 120. The power supply unit 110 is also connected to the control unit 120 and can be controlled by the control unit 120 particularly in order to switch between current regulation (I-charging phase) and voltage regulation (U-charging phase).

In addition, each battery cell 201, 202, 203, 204 is associated with a respective measuring device 140 for determining the charging voltage and a temperature sensor 150 for detecting the temperature. The measuring devices 140 and the temperature sensors 150 are likewise connected to the control unit 120 so that the control unit 120 is able to control the sequential charging of the battery cells 201, 202, 203, 204 as a function of the measured voltage and temperature. When the temperature exceeds or falls below a predetermined temperature threshold, the control unit 120 uses the switch 130 to interrupt the charging of the relevant battery cell and continue the charging with another battery cell. This case, however, should be left out of consideration below, i.e. the temperature of the battery cells 201, 202, 203, 204 is within a predetermined temperature range.

The battery cells 201, 202, 203, 204 can be individual rechargeable batteries that can be inserted into corresponding battery slots of the charging system 100. In such an embodiment, the individual components (110, 120, 130, 140, 150) of the charging system 100 can be embodied as one unit so that the system 100 constitutes a charging device. Alternatively, the battery cells 201, 202, 203, 204 can represent interconnected cells of an accumulator pack. In such a ease, the voltage measuring devices 140, the temperature sensors 150 (and optionally the switches 130) can be integrated into the accumulator pack so that only the power supply unit 110 and the control unit 120 (and optionally the switches 130) constitute a charging device that can be connected via a corresponding plug connection or interface to the accumulator pack and thus to the other components of the system 100 for charging battery cells 201, 202, 203, 204.

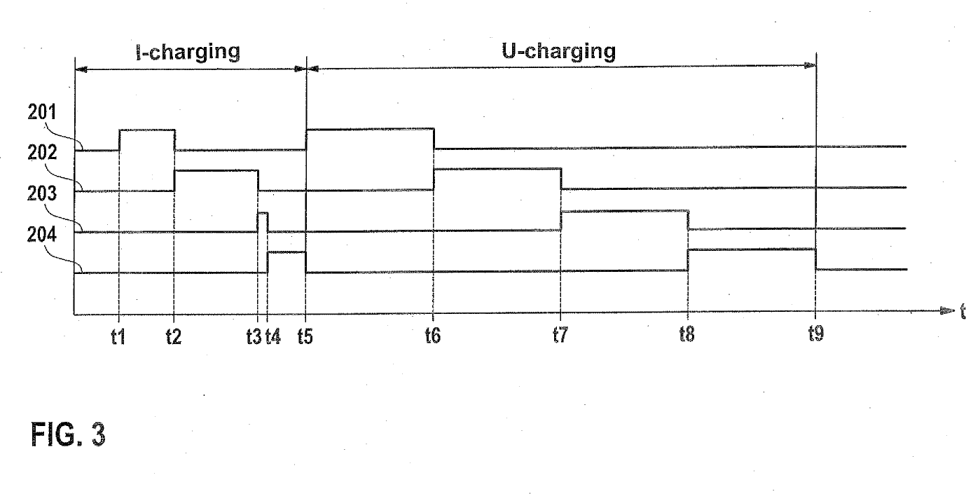

FIG. 3 shows an example of a charging graph illustrating a possible operation of the charging system 100 from FIG. 2. In this case, the charging functions of the individual battery cells 201, 202, 203, 204, i.e. whether the battery cells are being charged or not are plotted over time t, one above the other. At a time t1, the charging of the battery cell 201 with a constant current (I-charging phase) begins. The control unit 120 determines that the charging starts with the battery cell 201 (and also determines when the switch to the other battery cells 202, 203, 204 is made at later times). At time t1, the battery cell 201 is fully discharged or has a (low) partial capacity such that in the battery cell 201, a corresponding voltage is present at which the battery cell 201 is (still) being charged with current limitation (I-charging). In the course of the charging of the battery cell 201, the voltage increases in accordance with the curve shown in FIG. 1.

At a time t2, the predetermined limit voltage, for example the final charging voltage, is reached so that the charging of the battery cell 201 is interrupted and the charging is then continued with the battery cell 202. The control unit 120 executes this by activating and deactivating the associated switches 130. A corresponding voltage below the limit voltage is also measured in the battery cell 202 so that the battery cell 202 is charged at a constant current. At a time t3, the limit voltage is once again reached so that the charging of the battery cell 202 is interrupted and the charging is then continued with the battery cell 203.

By contrast with the battery cells 201 and 202 at times t1 and t2, however, the battery cell 203 already has a partial capacity such that it yields a voltage equal to the predetermined limit voltage or greater than the predetermined limit voltage in the battery cell 203, i.e. the battery cell 203 already has a charge state at which the battery cell 203 would need to be charged with voltage limitation (U-charging). Consequently, after a relatively short period of time, in which this voltage value of the battery cell 203 is detected, at a time t4, the charging of the battery cell 203 is interrupted and the charging is then continued with the battery cell 204. In the battery cell 204, a voltage below the predetermined limit voltage is in turn measured so that the battery cell 204 is charged at a constant current until the limit voltage is reached at a time t5.

At time t5, all of the battery cells 201, 202, 203, 204 have a charge state after which the battery cells 201, 202, 203, 204 are to be charged with voltage limitation (U-charging). The charging system 100 or more precisely stated, the control device 120, is embodied to detect such a state of all of the battery cells 201, 202, 203, 204. This can be carried out, for example, on the basis of the above-described “changeovers” from one battery cell to the next. For this purpose, the control unit 120 can include a memory device in which the charging changeovers are stored.

At time t5, therefore, the charging of the battery cell 204 is interrupted and the charging is then continued with the battery cell 201, which is then charged with a constant voltage (U-charging), with the current decreasing in accordance with the curve shown in FIG. 1. When the maximum charge state of the battery cell 201 is reached at time t6, the charging of the battery cell 201 is interrupted, and the charging is then continued with the next battery cell 202. This procedure is correspondingly repeated at other times t7 and t8 until at time t9, all of the battery cells 201, 202, 203, 204 have reached their maximum charge state and the charging procedure can be terminated or can alternatively be switched to a charge maintenance mode. The reaching of the maximum charge state of a battery cell is detected when a predetermined minimum charge current is reached or fallen below. For this purpose, the power supply unit 110, for example, is equipped with a corresponding current measuring device or else it enlists the aid of a measuring device that is used in the current regulation (I-charging).

The charging graph from FIG. 3 represents a possible example of the function of the charging system 100 from FIG. 2, which is based on the above-mentioned charging principle of interrupting the charging of one battery cell in the I-charging phase when a predetermined limit voltage or the final charging voltage is reached in order to continue the charging with another battery cell. This makes it possible in particular to start by very efficiently charging all of the battery cells in the I-charging phase before the charging is continued in the less efficient U-charging phase. For a predetermined period of time, which is shorter than a period of time required to fully charge all of the battery cells, this “two-stage” method is able to feed a larger energy quantity into the battery cells. When charging the battery cells 201, 202, 203, 204 according to the charging graph from FIG. 3, if the charging procedure is terminated, for example, between times t5 and t6 because a user needs the battery cells 201, 202, 203, 204 to operate an electrical device, then the battery cells 201, 202, 203, 204 have a greater “overall charge quantity” as compared to a charging of the battery cells in a manner in which each battery cell is charged in the I-charging phase and then the U-charging phase in immediate succession.

With regard to the charging graph from FIG. 3, other charging graphs and methods are possible. For example, it is conceivable at time t5 (at which each of the battery cells 201, 202, 203, 204 has a charge state that requires (further) charging accompanied by voltage limitation) to continue charging the battery cell 204 by making a switch from current limitation to voltage limitation in lieu of interrupting the charging of the battery cell 204 and continuing the charging with the battery cell 201. There is also another more complex charging curve, provided that a switch from one battery cell to the next also occurs when the temperature exceeds or falls below a predetermined temperature threshold. It is also conceivable to replace one or more of the battery cells with other battery cells during the charging, provided that the battery cells are individual rechargeable batteries. For such cases, the charging system 100 or more precisely stated, the control unit 120, can be embodied to initially charge all of the battery cells in the efficient I-charging phase and only after this, charge them in the U-charging phase.

In another alternative embodiment, the predetermined limit voltage—at which the charging of one battery cell in the I-charging phase is interrupted and the charging is continued with another battery cell—is a lower voltage than the final charging voltage. In such a case, all of the battery cells can initially be charged until a predetermined limit voltage is reached, before a charging “above” this limit voltage is continued while still using the current limitation (I-charging). In this case, when the final charging voltage is reached, a new changeover to another battery cell can take place so that the charging method is based on two limit voltages (i.e. the “predetermined” limit voltage and the final charging voltage).

Furthermore, the charging system 100 shown in FIG. 2 represents only one possible embodiment of the invention. There are also conceivable embodiments of a system that can include other modifications. In particular, the charging system can be embodied to charge a larger or smaller number of battery cells.

The foregoing relates to preferred exemplary embodiments of the invention, it being understood that other variants and embodiments thereof are possible within the spirit and scope of the invention, the latter being defined by the appended claims.

1. A method for electrically charging a plurality of rechargeable battery cells, in which the battery cells are embodied for a charging with a constant current and an increasing voltage in a first phase, and are embodied for a charging with a constant voltage and a decreasing current in a second phase following the first phase, and the battery cells are charged sequentially so that only one of the battery cells is charged at a time, and the method including charging one battery cell in the first phase, interrupting the charging of the one battery cell in the first phase when a predetermined limit voltage is reached, and continuing the charging of the one battery with an other battery cell in the second phase.

2. The method as recited in claim 1, wherein a predetermined limit voltage is a voltage at which a battery cell charged in the second phase.

3. The method as recited in claim 2, wherein if, in the charging of the other battery cell with which the charging is continued, the predetermined limit voltage is present, then the charging of the other battery cell is interrupted and the charging is continued with a different battery cell.

4. The method as recited in claim 1, further including initially charging all of the battery cells in the first phase and then charging at least one of the battery cells in the second phase.

5. The method as recited in claim 2, further including initially charging all of the battery cells in the first phase and then charging at least one of the battery cells in the second phase.

6. The method as recited in claim 3, further including initially charging all of the battery cells in the first phase and then charging at least one of the battery cells in the second phase.

7. The method as recited in claim 4, further including interrupting the charging of the at least one battery cell in the second phase when a predetermined minimal current is fallen below and continuing the charging with another battery cell.

8. The method as recited in claim 5, further including interrupting the charging of the at least one battery cell in the second phase when a predetermined minimal current is fallen below and continuing the charging with another battery cell.

9. The method as recited in claim 6, further including interrupting the charging of the at least one battery cell in the second phase when a predetermined minimal current is fallen below and continuing the charging with another battery cell.

10. The method as recited in claim 1, wherein the battery cells are lithium-based battery cells.

11. The method as recited in claim 2, wherein the battery cells are lithium-based battery cells.

12. The method as recited in claim 3, wherein the battery cells are lithium-based battery cells.

13. The method as recited in claim 1, wherein the battery cells are lithium-ion or lithium-polymer cells.

14. The method as recited in claim 2, wherein the battery cells are lithium-ion or lithium-polymer cells.

15. The method as recited in claim 3, wherein the battery cells are lithium-ion or lithium-polymer cells.

16. The method as recited in claim 1, further including measuring a temperature of the battery cells and if the temperature measured during the charging of one battery cell exceeds or falls below a predetermined temperature threshold, then the charging of the one battery cell is interrupted and the charging is continued with another battery cell.

17. The method as recited in claim 9, further including measuring a temperature of the battery cells and if the temperature measured during the charging of one battery cell exceeds or falls below a predetermined temperature threshold, then the charging of the one battery cell is interrupted and the charging is continued with another battery cell.

18. A charging system for electrically charging a plurality of rechargeable battery cells, having:
a charging device for selectively charging one of the respective battery cells which device is embodied to charge one battery cell with a constant current and an increasing voltage in a first phase and with a constant voltage and a decreasing current in a second phase following the first phase, a measuring device for determining a voltage during the charging of the battery cells, and a control unit, which is connected to the charging device and to the measuring device and is for controlling the selective charging of the battery cells, wherein the control unit is embodied to interrupt the charging of one battery cell in the first phase when a predetermined limit voltage is reached and to continue the charging with another battery cell.

19. The charging system as recited in claim 9, wherein the battery cells are lithium-based battery cells.

20. The charging system as recited in claim 9, wherein the battery cells are lithium-ion or lithium-polymer cells.
